(19) United States
(12) Patent Application Publication
(10) Pub. No.: US 2014/0112021 A1
(43) Pub. Date: Apr. 24, 2014

(54) BACKLIGHT MODULE

(71) Applicant: Shenzhen China Star Optoelectronics Technology Co. Ltd., Shenzhen, Guangdong (CN)

(72) Inventors: Lifeng Wang, Shenzhen (CN); Yuchun Hsiao, Shenzhen (CN); Yi-cheng Kuo, Shenzhen (CN)

(73) Assignee: Shenzhen China Star Optoelectronics Technology Co. Ltd., Shenzhen, Guangdong (CN)

(21) Appl. No.: 13/703,354

(22) PCT Filed: Nov. 16, 2012
(86) PCT No.: PCT/CN12/84754

§ 371 Date: Dec. 11, 2012

(30) Foreign Application Priority Data
Oct. 24, 2012 (CN) 201210409081.1

(51) Int. Cl. F21V 8/00

(52) U.S. Cl. CPC G02B 6/0081
USPC 362/633; 362/634

(57) ABSTRACT

The present invention relates to a backlight module, which comprises a backplate, and a backlight assembly fixed in the backplate by a positioning structure, the positioning structure comprises a positioning member used for fixing the backlight assembly and provided with a recess, and a protruding part arranged on the backplate, the backlight assembly is fixed in the backplate by engagement of the recess of the positioning member with the protruding part of the backplate. By the protruding part on the backplate and the recess on the positioning member to engage with the protruding part, the problem of poor product appearance due to exposure of the bump of the positioning member is resolved well.

### FIELD OF THE INVENTION

The present invention relates to the field of display devices, and more particularly to a backlight module.

### BACKGROUND OF THE INVENTION

The light guide plate and the optical film 1 of the existing backlight module are positioned with the positioning member 2 that is fixed at the four corners of the backplate 3. This fixing method can save the cutting costs of the positioning notch, thus reducing the cost of the backlight module. The structure is specifically as follows: The positioning member 2 is provided with a bump 4, and the backplate 3 is provided with a positioning hole to be fitted for the bump 4. In order to prevent the positioning member 2 from reducing the optical efficiency due to absorption of light, the positioning member 2 is generally made of white materials. After the entire TV is assembled, with the addition of the rear cover of the TV, the white positioning member exposed from the backplate 3 is covered inside the TV and will not affect the TV appearance. However, when this design is applied to the all-in-one machine, with the backplate part of the backlight module as an appearance member of the TV, the bump 4 of the positioning member 2 at the four corners of the backplate 3 is not covered by the rear cover of the TV, and thus affects the appearance of the product for not harmonizing with the color of the TV.

### SUMMARY OF THE INVENTION

Aiming at the above defects in the prior art, the technical problem to be solved by the present invention is to provide a backlight module.

The present invention adopts the following technical solution to solve its technical problem: a backlight module is provided, comprising: a backplate, and a backlight assembly fixed in the backplate by a positioning structure, the positioning structure comprises a positioning member used for fixing the backlight assembly and provided with a recess, and a protruding part arranged on the backplate, the backlight assembly is fixed in the backplate by engagement of the recess of the positioning member with the protruding part of the backplate.

The backlight module of the present invention, wherein the protruding part comprises a folded portion folded inwardly at the edge of the backplate.

The backlight module of the present invention, wherein the folded portion comprises a first folded portion extending inwards into the backplate, and a second folded portion extending upward from an end of the first folded portion; the recess of the positioning member engages with the second folded portion.

The backlight module of the present invention, wherein the protruding part includes a cylindrical pin, and the recess includes a through hole.

The backlight module of the present invention, wherein the backlight assembly includes a plurality of overlapped optical films, and a light guide sheet and a reflection sheet successively arranged under the bottom of the optical films.

The backlight module of the present invention, wherein the positioning member is provided with an axis pin, and the optical film is provided with a through hole to join with the axis pin.

The backlight module of the present invention, wherein the backlight module further comprises a front frame buckled on the backplate.

The backlight module of the present invention, wherein the backlight module further includes a middle frame arranged between the front frame and the backplate, and a liquid crystal screen clamped between the front frame and the middle frame and located above the backlight assembly.

The backlight module of the present invention has the following beneficial effects: by the protruding part on the backplate and the recess on the positioning member to engage with the protruding part, the problem of poor product appearance due to exposure of the bump of the positioning member is resolved well.

### BRIEF DESCRIPTIONS OF THE DRAWINGS

The present invention will further be explained with reference to drawings and examples. In the drawings:

FIG. 1 is a structural schematic drawing of the positioning means of the light guide plate and the optical film in the prior art;

FIG. 2 is a partial structural schematic drawing of the preferred example of a backplate module of the present invention;

FIG. 3 is a structural schematic drawing of the positioning member of the preferred example of the backplate module of the present invention;

FIG. 4 is an enlarged drawing of the part A in FIG. 1 of the preferred example of the backplate module of the present invention; and

FIG. 5 is a sectional view of the preferably example of the backplate module of the present invention.

### DETAILED DESCRIPTION OF THE EMBODIMENTS

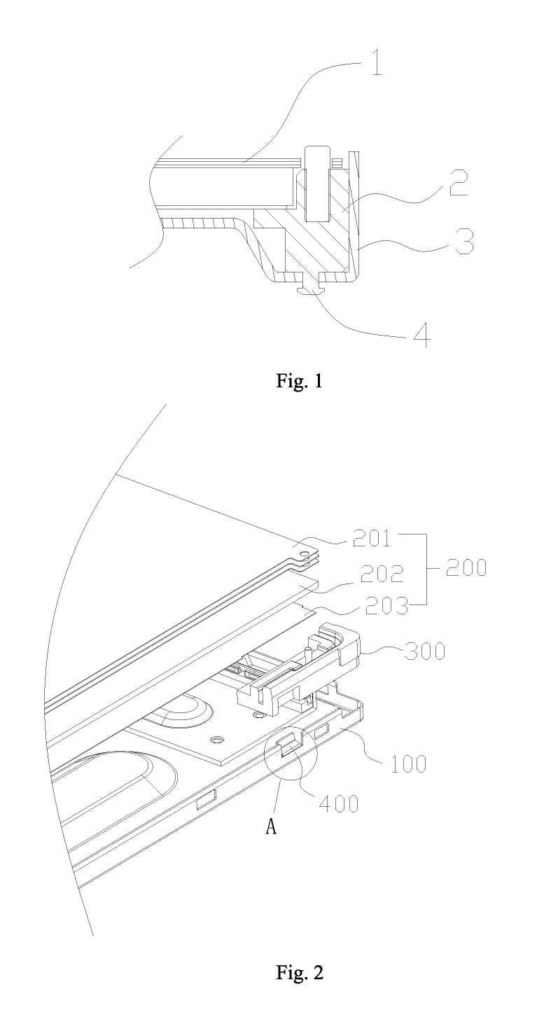

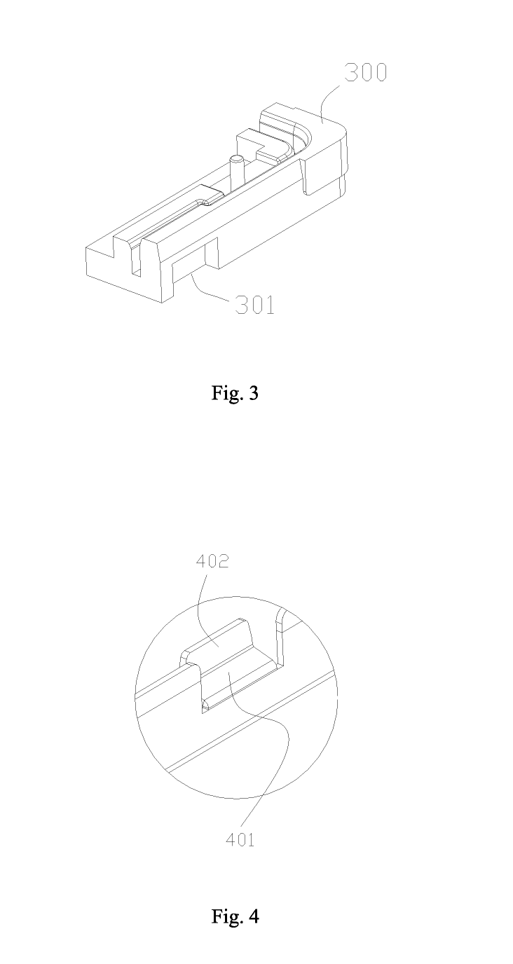

As shown in FIGS. 2-3, in the preferred example of the present invention, the backplate module includes a backplate 100, and a backlight assembly 200 fixed in the backplate 100 through a positioning structure, the positioning structure comprises a positioning member 300 used for fixing the backlight assembly 200 and provided with a recess 301, and a protruding part 400 arranged on the backplate 100, and the backlight assembly 200 being fixed in the backplate 100 by the recess 301 of the positioning member 300 engaging with the protruding part 400 of the backplate 100. The positioning member 300, as a middle member, is used for fixing the backlight assembly 200 inside the backplate 100; the backplate 100 is provided with the protruding part 400, and the positioning member 300 is provided with the recess 301, which can prevent the positioning member 300 from exposing on the backplate, thus eliminating the influence on appearance of the product.

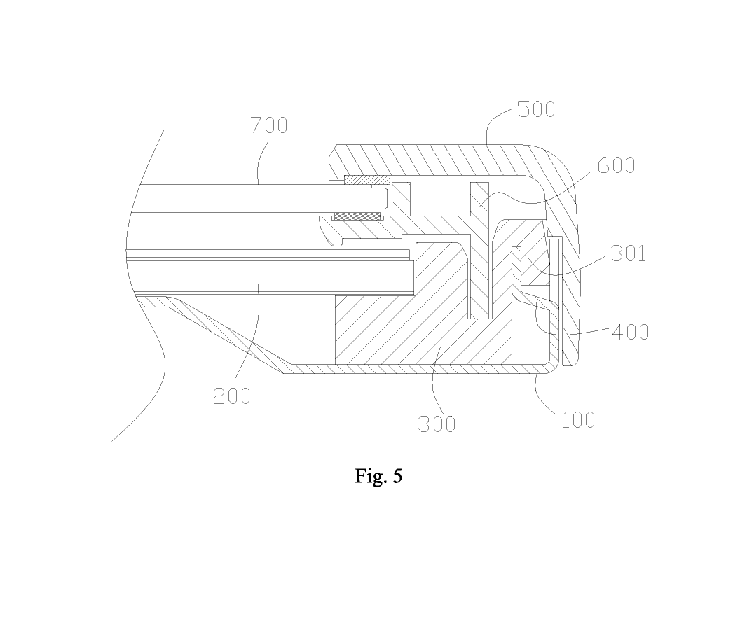

As shown in FIGS. 4-5, in the preferred example of the present invention, the protruding part 400 on the backplate 100 comprises a folded portion folded inwards at the edge of the backplate 100. The folded portion includes a first folded portion 401 extending into the backplate 100, and a second folded portion 402 extending upward from the end of the first folded portion 401. The recess 301 of the positioning member 300 engages with the second folded portion 402; specifically, the positioning member 300 has a recess 301 similar to an inverted L-shaped hook in shape, which just engages with the second folded portion 402. Because the folded portion 400 extends inwards into the backplate 100, the positioning member 300 will not be exposed on the backplate 100 to produce an influence on the product appearance.

The above positioning structure is not limited to the structure given in the present invention, for example, the protruding part 400 can also be a cylindrical pin protruding in the backplate 100, and the recess 301 on the positioning member 300 is correspondingly a through hole joined with the cylindrical pin.

In each of the above preferred examples, the backlight assembly 200 comprises a plurality of overlapped optical films 201, and a light guide sheet 202 and a reflection sheet 203 successively arranged under the bottom of the optical films 201. Generally, the positioning member 300 is provided with an axis pin, and the optical film 201 is provided with a through hole to join with the axis pin, a plurality of the optical films 201 being arranged on the positioning member 300 by join of the through hole with the axis pin; the light guide sheet 202 and the reflection sheet 203 are located under the bottom of the optical film 201, and thus pressed against on the positioning member 300 by the optical film 201, thereby completing the fixing.

Besides, this backlight module further comprises a front frame 500 buckled on the backplate 100, a middle frame 600 arranged between the front frame 500 and the backplate 100, and a liquid crystal screen 700 clamped between the front frame 500 and the middle frame 600 and located above the backlight assembly 200. The front frame 500 is buckled with the backplate 100, which can also achieve the purpose of covering the positioning structure, making the appearance of the product more harmonious and beautiful.

The above examples are used only for explaining the technical concept and features of the present invention. They are provided to make those skilled in the art understand the present invention and implement it, and cannot thereby limit the extent of protection of the present invention. Any equivalent alteration and modification within the scope of the claims of the present invention shall fall within the scope of the claims of the present invention.

1-8. (canceled)

9. A backlight module, comprising a backplate, and a backlight assembly fixed in the backplate by a positioning structure, wherein the positioning structure comprises a positioning member used for fixing the backlight assembly and provided with a recess, and a protruding part arranged on the backplate, the backlight assembly is fixed in the backplate by engagement of the recess of the positioning member with the protruding part of the backplate.

10. The backlight module according to claim 1, wherein the protruding part comprises a folded portion folded inwardly at an edge of the backplate.

11. The backlight module according to claim 2, wherein the folded portion comprises a first folded portion extending inwards into the backplate, and a second folded portion extending upward from an end of the first folded portion; the recess of the positioning member engages with the second folded portion.

12. The backlight module according to claim 1, wherein the protruding part includes a cylindrical pin, and the recess includes a through hole.

13. The backlight module according to claim 1, wherein the backlight assembly includes a plurality of overlapped optical films, and a light guide sheet and a reflection sheet successively arranged under the bottom of the optical films.

14. The backlight module according to claim 2, wherein the backlight assembly includes a plurality of overlapped optical films, and a light guide sheet and a reflection sheet successively arranged under the bottom of the optical films.

15. The backlight module according to claim 3, wherein the backlight assembly includes a plurality of overlapped optical films, and a light guide sheet and a reflection sheet successively arranged under the bottom of the optical films.

16. The backlight module according to claim 4, wherein the backlight assembly includes a plurality of overlapped optical films, and a light guide sheet and a reflection sheet successively arranged under the bottom of the optical films.

17. The backlight module according to claim 5, wherein the positioning member is provided with an axis pin, and the optical film is provided with a through hole to join with the axis pin.

18. The backlight module according to claim 1, wherein the backlight module further comprises a front frame buckled on the backplate.

19. The backlight module according to claim 7, wherein the backlight module further includes a middle frame arranged between the front frame and the backplate, and a liquid crystal screen clamped between the front frame and the middle frame and located above the backlight assembly.
